(19) United States
(12) Patent Application Publication
(10) Pub. No.: US 2026/0111981 A1
(43) Pub. Date: Apr. 23, 2026

(54) METHOD AND SYSTEM FOR GENERATING CAREER PROGRESSION PATH

(71) Applicant: Accenture Global Solutions Limited, Dublin (IE)

(72) Inventors: Koushik VIJAYARAGHAVAN, Chennai (IN); Mahesh ZURALE, Pune (IN); Sangeetha JAYARAM, Mumbai (IN); Krati SINGH, Hyderabad (IN); Divya SUDHAKARAN, Bengaluru (IN); Ashok VIRA, Mumbai (IN); Shaleen GARG, Gurgaon (IN); Dipti SHARMA, Gurgaon (IN); Priya ARUNACHALAM, Bangalore (IN); Sangeeta Swaminathan IYER, Bangalore (IN); Santosh SUNDARESAN, Chennai (IN); Chandrashekhar Arun DESHPANDE, Thane (IN); Sriram VENKATARAMANI, CANADA (CA); Renith VATTEKKAT, Thrissur (IN); Urvi MEHTA, Mumbai (IN); Sarabjit Singh GUGNEJA, Pune (IN); Sriraman DHANASEKARAN, Tiruchiappalli (IN)

(73) Assignee: Accenture Global Solutions Limited, Dublin (IE)

(21) Appl. No.: 18/922,988

(22) Filed: Oct. 22, 2024

(51) Int. Cl. G06Q 50/20; G06F 40/284; G06F 40/295

(52) U.S. Cl. CPC G06Q 50/2057; G06F 40/284; G06F 40/295

(57) ABSTRACT

A computer-implemented method and system to generate personalized career progression path are disclosed. The method may include obtaining data about work experience of an employee and computing a current role. Further, in a graphical user interface, a career universe comprising the current role of the employee and a set of potential career roles comprising may be presented. Furthermore, in the career universe, a relationship between the current role of the employee and the set of potential career roles may be identified. On receiving a selection of an aspirational role from the employee, at least one possible path from the current role of the employee to the aspirational role, along with the growth suggestions comprising one or more of articles, a certification or a learning experience for the employee to progress towards to the aspirational role, may be presented on the graphical user interface.

### TECHNICAL FIELD

Various embodiments described herein relate generally to determining personalized career progression path. Specifically, methods and systems for determining personalized career progression path based on skill information using generative artificial intelligence (Gen AI), machine learning (ML) and deep learning (DL) techniques are disclosed.

### BACKGROUND

In enterprise applications, where a multitude of career paths and opportunities exist, it is imperative to employ effective strategies for gathering and disseminating career-related information to employees, prospective employees, employers, and prospective employers. The success of an enterprise, as well as the satisfaction of its employees, relies on efficient employee recruitment and retention. Employees often seek information about available career opportunities within an enterprise, the necessary skills, preparation methods, potential career paths, and immediate steps to progress toward desired opportunities. Employers, on the other hand, may prioritize retaining top performers, effectively recruiting talent, and conveying available career growth paths. Additionally, they may aim to encourage employees to pursue career progression, thereby fostering skill development and knowledge acquisition.

### SUMMARY

Implementations of the present disclosure are generally directed to determining personalized career progression path using generative artificial intelligence (Gen AI), machine learning (ML) and deep learning (DL) techniques. More particularly, implementations of the present disclosure are directed to systems and methods for determining personalized career progression path based on skill information.

In general, innovative aspects of the subject matter described in this specification provide systems and methods for determining personalized career progression path based on skill information. The method may include obtaining data from a variety of different data source systems about work experience of an employee. Further, the method may include computing, for the employee and based on the data and via an artificial intelligence model and an ontology model, a current role of the employee, wherein the artificial intelligence model is trained using an unsupervised approach to generate a knowledge graph by combining the data from the variety of different data source systems, data classification and triple extraction. Further, the method may include presenting, in a graphical user interface configured on a display of a computing device, a career universe comprising the current role of the employee, a set of potential career roles comprising a first set of growth prospect roles presented in a first color, a second set of high affinity prospect roles in a second color and a third set of moderate or lower affinity prospect roles presented in a third color, wherein the career universe is presented in a precomputed manner based on skill computation rules related to one or more of capabilities, job families, and skill proficiency percentages. Moreover, the method may include identifying, in the career universe, a relationship between the current role of the employee and the set of potential career roles. A selection of an aspirational role from the set of potential career roles may be received from the employee. Thereafter, the method may include presenting, on the graphical user interface and in the career universe, at least one possible path from the current role of the employee to the aspirational role, the at least one possible path comprising a shortest path to the aspirational role. Additionally, the method may include presenting, in the graphical user interface as part of the career universe, via a query to the knowledge graph and in the career universe, growth suggestions comprising one or more of articles, a certification or a learning experience for the employee to progress towards to the aspirational role.

The present disclosure further describes a system for implementing the method provided herein. The present disclosure also describes computer-readable storage media coupled to one or more processors and having instructions stored thereon which, when executed by the one or more processors, cause the one or more processors to perform operations in accordance with the method described herein.

It is appreciated that methods in accordance with the present disclosure can include any combination of the aspects and features described herein. That is, the method in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DRAWINGS

Various embodiments in accordance with the present disclosure will be described with reference to the drawings, in which:

FIG. 1 illustrates an example environment that may be used to execute implementations of the present disclosure.

FIG. 2 illustrates an example block diagram of a system for generating personalized career progression path, in accordance with implementations of the present disclosure.

FIG. 3 illustrates an example block diagram of the data extractor in accordance with implementations of the present disclosure.

FIG. 4 illustrates an example graphical user interface (GUI) view of the set of potential roles on the graphical user interface, in accordance with implementations of the present disclosure.

FIG. 5 illustrates an example graphical user interface view of the career universe on the graphical user interface, in accordance with implementations of the present disclosure.

FIG. 6 illustrates an example block diagram that represents personalized content and role recommendations to the employees based on their article history, in accordance with implementations of the present disclosure.

FIG. 7 illustrates a flow diagram of an example method for determining personalized career progression path, in accordance with implementations of the present disclosure.

FIG. 8 illustrates a flow diagram of an example method for obtaining the data from the data source, in accordance with implementations of the present disclosure.

FIG. 9 illustrates an example computer system that may be used to implement the system to determine personalized career progression path in accordance with implementations of the present disclosure.

Like reference numbers and designations in the various drawings indicate like elements.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope of the claimed subject matter.

Reference to any “example” (e.g., “for example”, “an example of”, by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to”; it specifically indicates open-ended inclusion or membership in the so-described combination, group, series and the like.

The term “a” means “one or more” unless the context clearly indicates a single element.

“First,” “second,” etc., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures, and techniques may be shown without unnecessary detail in order to avoid obscuring example embodiments.

The specification and drawings are to be regarded in an illustrative rather than a restrictive sense. It will, however, be evident that various modifications and changes may be made thereunto without departing from the broader spirit and scope of the invention as set forth in the claims.

In enterprise environments, where diverse career opportunities and pathways abound, effective career information systems are crucial for both employee retention and recruitment. Within an enterprise, employees often seek information on available career opportunities, required skills, development paths, and preparation steps to progress towards their desired roles. This includes understanding immediate actions they can take to advance their careers. Similarly, employers are concerned with retaining top talent and attracting new hires by effectively communicating available career growth opportunities. They aim to encourage their workforce to pursue professional development, fostering a culture of continuous learning and skill acquisition.

Conventionally, employees seeking career advancement often rely on external websites.

However, these platforms typically offer generic information that might not be tailored to their specific skill sets and career aspirations. Moreover, data/information from external websites are fragmented, inaccurate, or outdated, making it difficult to assess an employee's skills and qualifications accurately. Algorithms used to process and analyze the said data inadvertently perpetuate biases present in the data, leading to discriminatory outcomes. Furthermore, this reliance on external resources can potentially lead to higher employee turnover by fostering a focus outside the enterprise for professional development opportunities. Investing in employee development can be a significant resource expenditure. If an employee possesses the necessary capabilities for their desired career role but lacks clarity regarding career progression within the current organization, there is a risk of employee attrition. Thus, when an employee leaves an organization due to a lack of career progression, it can result in a significant loss of organizational and industrial resources. For example, if an employee has received extensive training and development within the organization, their departure means that those investments are effectively wasted.

Therefore, there is a need for methods and systems to provide dynamic guidance to the employees to explore career possibilities as per their aspirations. Additionally, methods and systems are required to grow future talent by enabling the practice leaders to move from skill-development to career-development for internal supply of future skills and retain experienced talent. The job market is constantly evolving, with new skills emerging and existing ones becoming obsolete. This requires organizations to adapt their training and recruitment strategies. Moreover, there is need to provide employees guidance on selecting relevant training and certification programs to enhance their skills and advance their careers.

In view of this, in the present disclosure, a technique to determine personalized career progression path, to overcome above mentioned drawbacks of a conventional method is described.

Specifically, in the present disclosure, based on the skill, interest area and current role, personalized career progression path along with training and learning recommendations are provided to employees of an organization. The proposed technique computes current role of the employee, based upon various data about work experience of an employee, that is updated continuously as per the pace of time and technology changes in the market. Further, the proposed technique recommends the career progression path including, all possible traversal paths with respective recommended skills, roles, interest area, learning and certification, based on aspirational role selected by the employee. Additionally, employee can be provided with the information of foundation skills, technology skills and learning recommendations to achieve their aspirations. Moreover, a recommendation of a shortest path to the employee's desired role that is beneficial for the career growth is also computed and presented to the employee.

Moreover, in the present disclosure, ability of the system to continuously compute employee role relations and training/learning recommendations ensures that it remains relevant even in the face of organizational changes, skill transitions, and market fluctuations. Furthermore, the integration of diverse data sources in real-time, along with standardization and de-duplication, enables the system to provide accurate and up-to-date information. Specifically, in the present disclosure, the vast amount of data can be integrated from data sources on real time basis and aggregated into a knowledge graph using a unified graph schema. The data is distributed across several systems and stored in different formats. Each system follows a specific schema. In the present disclosure, use of knowledge graph platform may connect the data obtained from data sources, queries the data, and virtualizes the data to an otology model. Furthermore, the present disclosure, by utilizing knowledge graph, identifies the relationships between skills, learning, and certification, and thereby allows the system to provide more personalized and effective guidance. The real-time data integration and co-relation of nodes and relationships help the system stay updated with market trends and suggest appropriate skills and certifications. In essence, the present disclosure provides a clear understanding of an employee's career progression by mapping their skills to roles and identifying potential growth paths.

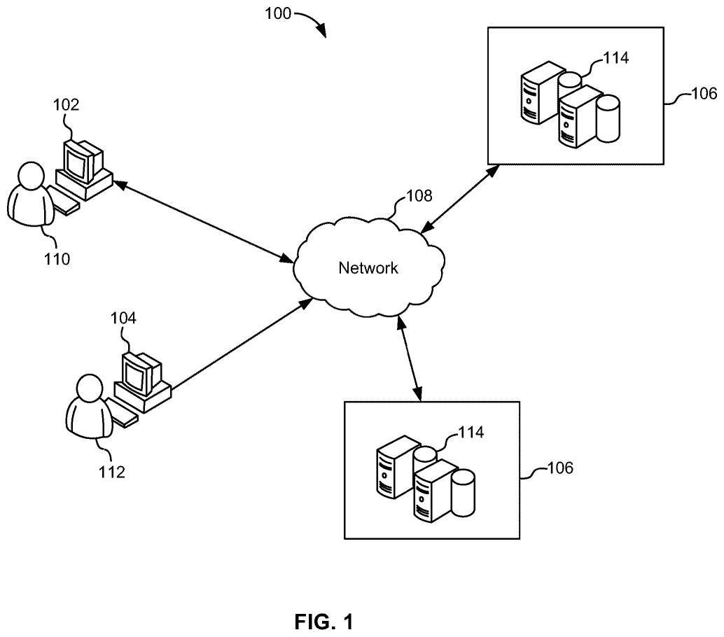

FIG. 1 illustrates an example environment 100 that may be used to execute implementations of the present disclosure. In some examples, the example environment 100 enables users associated with respective systems to execute requests to generate content by invoking a trained language model in accordance with implementations of the present disclosure.

The example environment 100 includes computing devices 102 and 104, back-end systems 106, and a network 108. In some examples, the computing devices 102 and 104 are used by respective users 110 and 112 to log into and interact with the platforms and execute applications according to implementations of the present disclosure.

In the depicted example, the computing devices 102 and 104 are depicted as desktop computing devices. It is contemplated, however, that implementations of the present disclosure can be realized with any appropriate type of computing device (e.g., smartphone, tablet, laptop, personal computer, voice-enabled devices, etc.). In some examples, the network 108 includes a local area network (LAN), wide area network (WAN), the Internet, or a combination thereof, and connects web sites, user devices (e.g., computing devices 102, 104), and back-end systems (e.g., the back-end systems 106). In some examples, the network 108 can be accessed over a wired and/or a wireless communications link. For example, mobile computing devices, such as smartphones can utilize a cellular network to access the network 108.

In the depicted example, each of the back-end systems 106 includes at least one server system 114. In some examples, the at least one server system 114 hosts one or more computer implemented services that users can interact with using computing devices (e.g., computing devices 102 and/or 104). For example, components of enterprise systems and applications can be hosted on one or more of the back-end systems 106. In some examples, a back-end system can be provided as an on-premises system that is operated by an enterprise or a third-party taking part in cross-platform interactions and data management. In some examples, a back-end system can be provided as an off-premises system (e.g., cloud or on-demand) that is operated by an enterprise or a third-party on behalf of an enterprise.

In some examples, the computing devices 102 and 104 each includes computer-executable applications executed thereon. In some examples, the computing devices 102 and 104 each includes a web browser application executed thereon, which can be used to display one or more web pages of applications executing on the back-end system 106. In some examples, each of the computing devices 102 and 104 can display one or more graphical user interfaces (GUIs) enabling the respective users 110 and 112 to interact with the back-end system 106. In accordance with implementations of the present disclosure, the back-end systems 106 may host enterprise applications or systems that require data sharing and data privacy. In some examples, the computing device 102 and/or the computing device 104 can communicate with the back-end systems 106 over the network 108.

In some implementations, at least one of the back-end systems 106 can be implemented in a cloud environment that includes at least one server system 114. In the example of FIG. 1, the back-end system 106 includes various forms of servers including, but not limited to, a web server, an application server, a proxy server, a network server, and/or a server pool. In general, server systems 114 accept requests for application services and provide such services to any number of client devices (for example, the computing device 102 over the network 108).

In some implementations, the back-end system 106 can be used to implement an Artificial Intelligence (AI)-enabled platform trained to generate content relevant for individuals in accordance with contextual information and training data indicative of reactions of similar consenting individuals to certain content items (e.g., neuroscience responses). The AI-enabled platform can include a trained AI model that generates such personalized content.

Various examples depicting generation of personalized career progression path are described in detail in conjunctions with figures below.

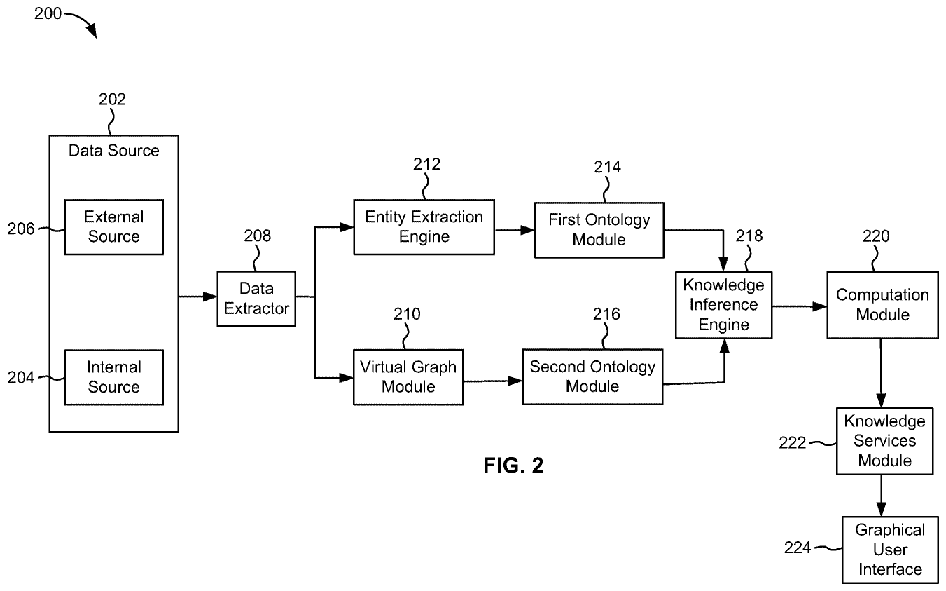

FIG. 2 illustrates an example block diagram of a system 200 for generating personalized career progression path, in accordance with implementations of the present disclosure. The system 200 may include a data source 202, a data extractor 208, an entity extraction engine 212, a virtual graph module 210, a first ontology module 214, a second ontology module 216, a knowledge inference engine 218, a computation module 220, a knowledge services module 222 and a graphical user interface 224.

The data source 202 may further include an internal source 204 and an external source 206. The data obtained from the internal source 204 may include, but not limited to, employee data, skill data, training certifications, demand data and credential data for the employee. The internal source 204 may provide data related to the employees within the organization. Moreover, the internal source 204 may maintain information related to employee and a complete history of the employee's career profile in the organization. In addition to the internal source 204, the data pertaining to the employee may also be obtained from the external source 206 which can provide information about the employee's areas of interests, certifications/trainings enrolled and completed, past/present skills, past/present work experience, etc. The data obtained from the external source 206 may include, but not limited to, a job-related social media site (for example, LinkedIn), a microsite, time-series documents (for example, Kx documents), a really simple syndication (RSS) feed, blogs, articles and a website for sharing human stories and ideas (for example, medium.com). The external source 206 may provide information of trends, industry standards, and competitive landscapes. Additionally, the external source 206 may supplement internal source 204 to provide information of employee's skills and career opportunities. In essence, the data obtained from the internal source 204 and external source 206 may be further processed to identify employee skills and qualifications, identify career opportunities, monitor employee performance, and identify areas for improvement.

The data obtained from the data source 202 may include one or more of a job family matrix, primary skill data, secondary skill data, area of work data, connector data, learnings data, from and to connector data, experience level data, and work capability data. Specifically, the job family matrix may be prepared by capability leads, defining the relationships between different roles within the organization. The job matrix may provide insights into career progression paths and potential roles within specific job families. The primary skill data and secondary skill data may represent the employee's core competencies and supporting abilities. The primary skill data and secondary skill data may facilitate identifying suitable roles and recommending relevant training and development opportunities. The area of work data may represent the specific field or domain in which the employee works, thereby narrowing down potential career paths and identifying roles that align with their area of expertise. The connector data may represent the relationships between roles within the organization. The connector data may identify potential career transitions and identify roles that are closely related to an individual's current position. The learning data may include information about training programs, certifications, and other learning experiences that an individual has completed. The from and to connector data may be derived based on the job family matrix, representing the potential transitions between roles within the organization. The from and to connector data may provide insights into career progression paths and identify potential next steps for the employee's career. The experience level data may indicate the employee's level of experience within their field. The experience level data may be used to assess the employee's readiness for different roles and identify appropriate career development opportunities. The work capability data may combine the information about the employee's roles, skills, learnings, and experience level to provide a comprehensive view of their capabilities. The work capability data may be used to identify suitable roles and recommend relevant training and development programs.

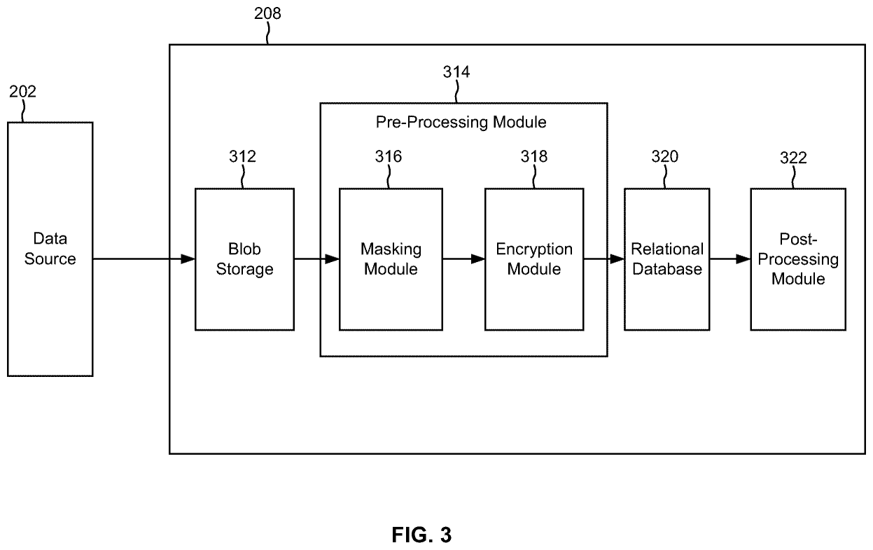

Further, the data extractor 208 may obtain data from a variety of different data source 202 systems (including the internal source 204 and external source 206) about work experience and skill of the employee (described further in FIG. 3 description). The obtaining of the data may occur as trigged by new data identified in one or more of the different data source 202 systems or on a scheduled basis. Specifically, the data extractor 208 may monitor the data source 202 for new or updated data. When the new data is identified in the data source 202, the data extractor 208 may obtain the new data or update data automatically. Furthermore, obtaining data by data extractor 208 may be scheduled to occur at regular intervals, such as daily, weekly, or monthly. This is suitable for scenarios where data updates are not time-sensitive, and a periodic refresh is sufficient. The data source 202 may include documents, articles, web pages, or any other textual content. The data extractor 208 may obtain structured and unstructured data from the data source 202. Further, the data extractor may identify and extract relevant information from the data by utilizing techniques such as, natural language processing (NLP), and domain-specific knowledge. In an example, the data extractor 208 may be a python Crawler, that may obtain data from the data source 202.

In further detail, the entity extraction engine 212 may prepare the data obtained from the data extractor 208, for subsequent processing. In particular, the entity extraction engine 212 may process the data received from external source 206. In an example, the entity extraction engine 212 may be stardog (an enterprise knowledge graph platform or module). Specifically, the entity extraction engine 212 may detect sentences in the data, tokenizes the data, extract named entities from the data, extract one or more subjects/predicates/objects from the data, perform predicate classification and validates a skill classification to generate a first ontology. Specifically, the detection of sentences in the data may include dividing the text into sentences, thereby, providing a granular level of data for further processing. The tokenization of the data may include breaking down each sentence into its constituent words or tokens, which are the fundamental building blocks of language.

Furthermore, the entity extraction engine 212 may utilize a natural language processing (NLP) library, for example, CoreNLP, to extract named entities (for example, people, organizations, locations, dates) within the text, specifically focusing on entities related to skills, training, and certifications. The NLP library may include a set of named entity recommendation models and provide state-of-the-art results on the given datasets. Thereafter, the subjects/predicates/objects from the data may be extracted. Herein, the subject, predicate, object may be referred as the triples.

The data may include a collection of triples (subject, predicate, object) that can form a large and complex graph-like structure. Specifically, the entity extraction engine 212 may include extracting the triples (subject, predicate, object) that represent the identified skills, training, or certifications and the associated information. Herein, the subject may represent an entity (for example, a person, organization, or concept), the predicate may represent a relationship or property, and the object may represent the value or entity associated with the subject. The entity extraction engine 212 may utilize a technique such as open information extraction (open IE) to analyze the text and identify subject-predicate-object relationships. In an example, the triple(S) may be represented as “Alice works in Delhi”. Herein, “Alice” may be the subject, “works at” may be the predicate and “Delhi” may be the object. Further, the extracted predicates may be classified into categories or types, thereby providing contextual information of the obtained data. For example, the entity extraction engine 212 may determine that a person “hasSkill” or “completedTraining.” Furthermore, predicates may be classified as “hasSkill,” “completedTraining,” or “obtainedCertification.”

Furthermore, the entity extraction engine 212 may utilize rule-based or machine learning (ML) techniques for predicate classification based on their semantic meaning or syntactic structure. Moreover, the identified skills may be compared against a pre-determined list of known or valid skills. The entity extraction engine 212 may evaluate the extracted data related to skills to determine their validity or relevance by comparing the identified skills against predefined lists of skills. Additionally, ML techniques may be utilized to determine the plausibility of the identified skills.

Thereafter, the first ontology module 214 may generate the first ontology. The generated first ontology may include data related to one or more of skill, training, learning material, certification, technology, and career opportunity. The data of first ontology may further be used in model training and entity linking for the knowledge graph in the knowledge inference engine 218 (described in further paragraphs).

In an instance, the first ontology may include a named graph for extracted named entities. Specifically, the named graph may hold the collection of the triples (subject, predicate, object), thereby allowing to organize and manage different sets of triples separately. Each named graph may have a unique identifier or name, which can be used to reference it.

In an example below, the first ontology module 214 may create the named graph, called “employeeData” and insert the triples (subject, predicate, object) representing employee information:

# Create a named graph called “employeeData”
CREATE GRAPH employeeData
# Insert SPO triples into the graph
INSERT DATA INTO employeeData {

<Alice> <worksAt> <Google> .
<Bob> <worksAt> <Microsoft> .
<Alice> <hasSkill> <Python> .
}

The first ontology module 214 may utilize platforms, such as Stardog and RDF4J, etc. to provide support for creating and managing the named graphs. The platforms may utilize query languages (for example, SPARQL) for ontology generation, graph visualization and integration with other data sources.

In further detail, the data obtained from the internal source 204 by the data extractor 208 may further be processed by the virtual graph module 210. The virtual graph module 210 may receive data from the data extractor 208 and generate one or more virtual graphs within the knowledge graph platform (for example, stardog), wherein, each virtual graph represents a specific data source or domain. The virtual graph may refer to conceptual representations of the data in a graph structure. Specifically, in the virtual graph a database management system (not shown in FIG. 2) may create triples associated with the data obtained from the internal source 204 using an ontology, validates constraints, defines axioms and defines user-defined rule reasoning to generate a second ontology related to one or more of the employees, a role, the skill, the job family matrix, a capability, a skill group, a demand and a project.

The database management system may create the triples (subject, predicate, object) associated with the data obtained from the internal source 204 using an ontology, via a resource description framework (RDF) data model. The RDF data model may be used for modeling the data as entities and the relationships between them. RDF may describe and exchange metadata, which enables standardized data exchange. Furthermore, the database management system may retrieve data from the internal source 204. The data may be in various formats (for example, relational tables, JSON documents, etc.). The database management system may transform the retrieved data into the triples (subject, predicate, object) by utilizing the RDF data model. The RDF data model may represent the data in a way that can be processed by virtual graph module 210. The generated triples (subject, predicate, object) may be organized into the one or more virtual graphs. Herein, the virtual graphs may represent the relationships between the data entities, thereby ensuring that the data may be represented in a standardized and meaningful way, facilitating interoperability between different systems.

Further, the virtual graph module 210 validates constraints by utilizing a language, such as Shapes Constraint Language (SHACL), thereby, ensuring data consistency and quality. The SHACL is a world wide web consortium (W3C) standard for validating RDF data against a pre-defined set of rules. Herein, the constraints may refer to rules or limitations that define the structure, content, and relationships of entities in the data. Specifically, the constraints validation may allow defining rules on the structure and content of RDF style graph database. Moreover, axioms may be defined in the ontology to express relationships between entities. Herein, axioms may be logical statements that express relationships between entities in the ontology and may be used for reasoning and inference. For example, an axiom may state that an employee can have multiple skills or that a role requires specific skills. Additionally, user-defined rule reasoning may be defined. Specifically, user-defined rule reasoning may be the custom rules that are defined to perform specific reasoning tasks. The custom rules may be used to infer additional information or to implement domain-specific logic. For instance, inferring additional information may include calculating derived properties, inferring new relationships, or applying domain-specific logic.

Consequently, a second ontology module 216 may generate a second ontology related to one or more of the employees, a role, the skill, the job family matrix, a capability, a skill group, a demand and a project. The second ontology may be generated, incorporating the results of the validation, axiom reasoning, and user-defined rule reasoning, in the virtual graph module 210. The second ontology may include additional concepts, properties, or relationships.

In further detail, the knowledge inference engine 218 may receive the first ontology and the second ontology to generate the knowledge graph with a dynamic ontology related to the employee, a roll, the skill, the job family matrix, the capability, the skill group, the training, the learning material, the certification, the technology, a career opportunity, the demand and the project. The dynamic ontology may evolve and adapt over time to incorporate new knowledge or changes in the domain. The dynamic ontologies may adapt over time via mechanisms such as, but not limited to, machine learning techniques and rule-based inference. Specifically, machine learning techniques may be used to analyze new data and automatically update the ontology. For example, a clustering technique may identify new groups of concepts, or a text mining technique may extract new terms and relationships from documents. The rule-based inference may include automatically inferring new data or relationships based on existing knowledge. Herein, the knowledge inference engine 218 may continuously update the dynamic ontology to incorporate new information, changes in relationships, or evolving domain knowledge. Specifically, an artificial intelligence (AI) model is trained using an unsupervised approach to generate the knowledge graph by extracting the data from the variety of different data source 202 systems, data classification and triple extraction. The knowledge inference engine 218 may identify patterns and correlations within the data, such as co-occurrence of terms or hierarchical relationships. Based on the extracted features and patterns, the AI model may generate the knowledge graph including nodes and edges. The nodes may represent entities and edges may represent relationship between the entities. Specifically, the knowledge graph may include a connectedness of the data such that the knowledge graph, via a unified schema, may be used to nature through multiple paths between the current role and the aspirational role. The unified schema may be a standardized framework or model that defines the structure and relationships of the data within the knowledge graph, thereby ensuring that the data may be represented consistently. For instance, the unified schema may define the types of entities (for example, roles, skills, certifications) and the relationships between them (for example, “requires,” “leads to,” “is a prerequisite for”).

The knowledge inference engine 218 may receive queries (from the computing devices 102 and 104) related to the axioms and rules associated with user-defined rule reasoning. The knowledge inference engine 218 may utilize the reasoning capabilities to process the query, applying axioms and rules to infer new information or answer the question. Moreover, the knowledge inference engine 218 may use the dynamic ontology and user-defined rules for semantic reasoning, enabling it to understand and process queries. Additionally, the knowledge inference engine 218 may provide a response (by utilizing the current role of the employee computed by the computation module 220) to the query, delivering knowledge services in the knowledge services module 222, related to various aspects of the career universe. The knowledge services module 222 may include, but not limited to, determining the current or potential roles of an employee based on their skills and experience, identifying the capabilities required for all roles in the organization, identifying potential career paths, including the shortest path to an aspirational role, suggesting popular or suitable roles based on an employee's skills, interests, or market demand, suggesting training or certification programs that can enhance an employee's skills and career prospects, identifying relevant career opportunities based on an employee's skills, experience, and market trends.

In further detail, the computation module 220 may compute, for the employee and based on the data and via the AI model and the ontology model, a current role of the employee. The current role of the employee may be computed based on entities like job family, skill, and attributes such as primary skills, secondary skills, level (experience) etc., by using query language (for example SPARQL). The query language may be driven by skill computation rules, which are used to assign roles to employees. The query language may be invoked by an application programming interface (API) that may accept input parameters, for example, employee ID and capability name. Thereafter, the API may send the input parameters to the language query, which filters the data based on the provided criteria and returns the corresponding role mapping for the specified employee.

In an example, the skill computation rules may include determining the employee roles based on primary and secondary skills, area of work, and career level. The employee's primary skill may be used to identify their capability. By analyzing the primary and secondary skills, relevant skill groups may be identified by using a skill group-skill mapping sheet associated with the respective capability. The employee's progression level may be classified as analyst for CL-10, 11, and 12, consultant for CL-8 and 9, and principal for CL-5, 6, and 7. Based on the identified skill groups, progression level, and area of work, potential roles may be computed by the computation module 220. A plurality of roles may be presented to the employee, based on this analysis. To select the most relevant roles, prioritization rules may be applied. The prioritization rules may include precedence of roles associated with the primary skill, followed by roles associated with secondary skills. Roles with a higher number of matching skills may be prioritized, and in cases of ties, proficiency may be used as a tiebreaker. Roles with the highest proficiency may be chosen, and if multiple roles have the same proficiency, the sum of their associated proficiency scores may be considered. If necessary, the final roles may be selected alphabetically.

Specifically, the computation module 220 may provide one or more roles for the employee at any given time. The computation module 220 may map the employee's primary skill to a capability within a specific job family at a particular career level, thereby, identifying suitable roles. This process is repeated using the employee's secondary skills, allowing for a broader range of potential roles to be considered. By analyzing these relationships, the computation module 220 may provide relevant career paths and opportunities tailored to the employee's skillset and career aspirations.

Moreover, the graphical user interface 224 may display a career universe comprising the current role of the employee and a set of potential career roles (on the computing devices 102 and 104). The set of potential career role may include a first set of growth prospect roles presented in a first color, a second set of high affinity prospect roles in a second color and a third set of moderate or lower affinity prospect roles presented in a third color. The set of potential career roles may be represented as career role bubbles in the career universe on the graphical user interface 224. The career universe may be presented in a precomputed manner based on skill computation rules related to one or more of capabilities, job families, and skill proficiency percentages. Furthermore, the graphical user interface 224 may identify, a relationship between the current role of the employee and the set of potential career roles in the career universe. On receiving a selection of an aspirational role from the set of potential career roles, from the employee, the graphical user interface 224 may present, in the career universe, at least one possible path from the current role of the employee to the aspirational role. The at least one possible path may include, but not limited to, a shortest path and an indirect path to the aspirational role. Specifically, the shortest path to the aspirational role may be a direct path between the employee's current role and the aspirational role. The shortest path to the aspirational role may be based on a fellow employee who has performed a role transition to the aspirational role.

For example, the employee's current role is “Data Engineering at Analyst level” and aspirational role is “Technology Delivery Lead at Principal level”, the progression levels for each of the current role and aspirational role may be expressed as per the below Table 1:

TABLE 1

| Data Engineering progression levels | Technology Delivery Lead progression levels |
|---|---|
| Analyst (Current role) | N/A |
| Consultant | Consultant |
| Principal | Principal (Aspirational role) |

The below two possible shortest paths considering the progression levels may be displayed, as expressed in Table 2:

TABLE 2

| | | | | Aspirational |
|---|---|---|---|---|
| | Current Role | Intermediate role | Intermediate role | Role |
| Shortest | Data Engineer | Data Engineer | Technology | Technology |
| Path 1 | (Analyst level) | (Consultant level) | delivery lead | delivery lead |
| | | | (Consultant | (Principal level) |
| | | | level) | |
| Shortest | Data Engineer | Data Engineer | Data Engineer | Technology |
| Path 2 | (Analyst level) | (Consultant level) | (Principal level) | delivery lead |
| | | | | (Principal level) |

Moreover, at least one of the indirect paths to the aspirational role may be presented on the graphical user interface 224. The indirect path may include an intermediate role from the current role of the employee and a natural progression path to the aspirational role.

For example, the employee's current role is “Artificial Intelligence Engineering at Consultant level” and aspirational role is “Enterprise Data strategy at Principal level”, the progression levels for each of the current role and aspirational role may be expressed as per the below Table 3:

TABLE 3

| Artificial Intelligence | | |
|---|---|---|
| Engineering progression | Data Science progression | Enterprise Data strategy |
| levels | levels | progression levels |
| Analyst | Analyst | N/A |
| Consultant (current role) | Consultant | N/A |
| Principal | Principal | Principal (aspirational role) |

The below two possible indirect paths considering the progression levels may be displayed, as expressed in Table 4. One indirect path may be displayed between the current role and the aspirational role and has the below two possible career paths considering the progression levels:

TABLE 4

| | | | | Aspirational |
|---|---|---|---|---|
| | Current Role | Intermediate role | Intermediate role | Role |
| Indirect | Artificial | Data Science | Data Science | Enterprise Data |
| Path 1 | Intelligence | (Consultant level) | (Principal level) | strategy |
| | Engineering | | | (Principal level) |
| | (Consultant level) | | | |
| Indirect | Artificial | Artificial | Data Science | Enterprise Data |
| Path 2 | Intelligence | Intelligence | (Principal level) | strategy |
| | Engineering | Engineering | | (Principal level) |
| | (Consultant level) | (Principal level) | | |

Additionally, the graphical user interface 224 may present via a query to the knowledge graph and in the career universe, growth suggestions including one or more of articles, a certification or a learning experience for the employee to progress towards to the aspirational role.

In another example, the career universe may be displayed on the graphical user interface 224 to represent entities such as, but not limited to, employees, roles, skills, capabilities, progression levels, and management levels. The mapping between career levels and progression levels may be defined as follows: analyst corresponds to Levels 11 and 10, consultant to Levels 8 and 9, and principal to Levels 7, 6, and 5. The data may be initially virtualized in the knowledge graph and then materialized using the copy command of the language query command (for example COPY <virtual graph> TO:<persisted graph>). In the materialized knowledge graph, each data entity may be represented as a node, and relationships between these nodes may be represented as an edge. Further, the relationships may be defined based on the first ontology, the second ontology and virtual graph mapping. Direct relationships may connect directly related entities, while inferred relationships may connect entities that are not directly related but may be inferred based on the defined mappings. To identify the shortest path between two nodes, the number of nodes traversed along the path may be calculated based on the progression levels associated with the roles, representing a natural career progression path. For example, the SPARQL query, “PATHS START ?x=:App Developer MS Analyst END ?y=:App Developer MS Principal VIA ?p, “may be used to find the shortest path between an analyst and a principal in the context of an App Developer MS role.

FIG. 3 illustrates an example block diagram of the data extractor 208, in accordance with implementations of the present disclosure. The data extractor 208 may include a blob storage 312, a pre-processing module 314, a relational database 320, a post-processing module 322. The pre-processing module 314 may further include a masking module 316 and an encryption module 318.

The data extractor 208 may extract the data from the data source 202 and move the data to the blob storage 312 to generate blob storage data. Specifically, the data extractor 208 may identify the various data sources (including external source 206 and internal source 204) from which data needs to be extracted. After the data sources are identified, appropriate connections may be established to access the data. For example, the connections may include, but not limited to, database queries, application programming interface (API), file transfers and data scrapping. The database queries may include using query languages (for example, SQL) to extract data directly from databases. The API may include interacting with application programming interfaces (APIs) provided by data source systems to retrieve data. The file transfers may include copying data files from source systems to a staging area. The data scraping may include extracting data from web pages or other unstructured sources. Thereafter, the data may be moved to the blob storage 312. The blob storage 312 may be a cloud-based storage service that stores unstructured data as blobs.

The blobs may be files of any type, such as images, videos, documents, or raw data. The blob storage 312 may scale up or down to meet dynamic storage needs, thereby storing structured and unstructured data that can grow rapidly over time. Moreover, the blob storage 312 may integrate seamlessly with other cloud services, such as analytics tools, machine learning platforms, and content delivery networks (CDNs), thereby simplifying data processing and distribution.

Furthermore, the data from the blob storage 312 may be processed by the pre-processing module 314. Specifically, the masking module 316 may identify the sensitive data within the blob storage data. The sensitive data may include personally identifiable information (PII), financial data, or other confidential information. The masking module 316 may replace the sensitive data with non-sensitive values while preserving the data's format and structure, thereby protecting sensitive information from unauthorized access. Moreover, the masking module 316 may utilize masking techniques like, but not limited to, randomization, tokenization, and substitution.

Thereafter, the encryption module 318 may encrypt the sensitive data within the blob storage data to generate encrypted data. For instance, the sensitive data may include employee name and organization ID. Specifically, the encryption module 318 may receive the data from the masking module 316 and transform the data into a scrambled format that may be unintelligible without a decryption key. The encryption module 318 may utilize a cryptographic technique (for example, SHA256). The cryptographic technique transforms the original data into an encrypted version that may be stored in the relational database 320.

Moreover, the pre-processing module 314 may include tracking the extracting of the data. Specifically, the pre-processing module 314 may audit system logs to track who extracted the data, when it was extracted, and for what purpose, as the system logs may contain information about the employee's actions, the application or process that initiated the extraction of data, and any related events. Furthermore, the masked data and the encrypted data received from the pre-processing module 314 may be loaded into the relational database 320 (for example, PostgreSQL) to generate relational database data. After the files are loaded to the relational database 320, the post-processing module 322 may delete the files from the blob storage 312, thereby reducing storage requirement and minimizing the risk of unauthorized access to sensitive data. Additionally, the post-processing module 322 may generate logs to record the process, including the time taken for each step, any errors encountered, and the success or failure of the upload. The logs may be used for auditing, troubleshooting, and performance analysis. The post-processing module 322 may also handle any errors or exceptions that may occur during the post-upload process. This may include sending notifications, retrying failed operations, or logging detailed error messages.

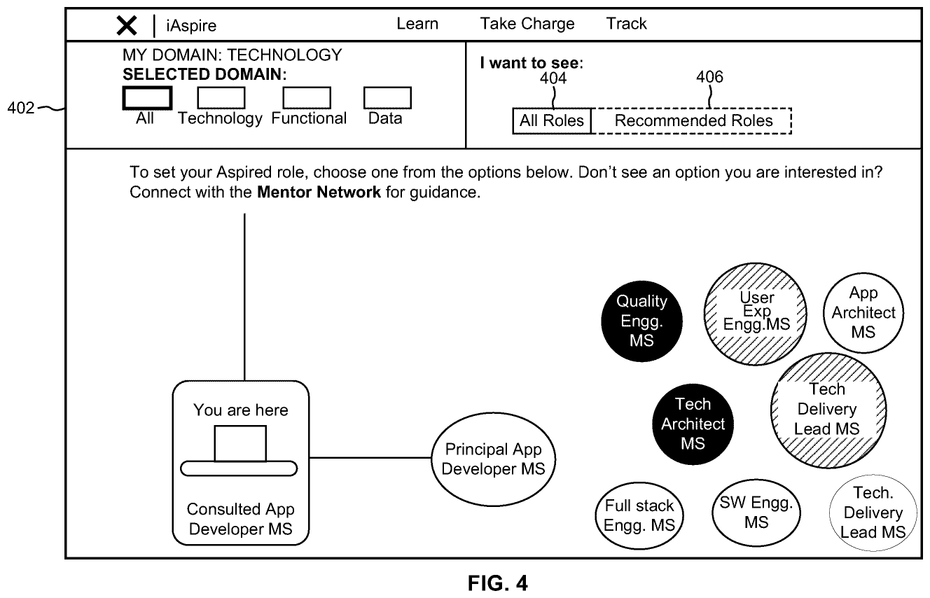

FIG. 4 illustrates an example graphical user interface (GUI) view of the set of potential roles on the graphical user interface 224 (on the computing devices 102 and 104), in accordance with implementations of the present disclosure. Herein, the set of potential career roles including the first set of growth prospect roles presented in the first color (represented as black career role bubbles), the second set of high affinity prospect roles in the second color (represented as shaded career bubbles) and the third set of moderate or lower affinity prospect roles presented in the third color (represented as white career role bubbles). Specifically, the first set of growth prospect roles presented in the first color (represented as black career role bubbles), may represent the most promising and directly accessible career roles for the employee. Further, the first set of growth prospect roles may be closely aligned with the user's current skills, experience, or career goals, making them the most likely candidates for immediate progression. The second set of high affinity prospect roles in the second color (represented as shaded career bubbles), may represent roles that are still considered promising but may require additional skills, experience, or qualifications to achieve. The second set of high affinity prospect roles may involve a transition in the current role or require targeted development efforts. The third set of moderate or lower affinity prospect roles presented in the third color (represented as white career role bubbles) may set represent roles that require a significant shift in skills or career direction. The third set of moderate or lower affinity prospect roles may require greater challenges (for example, acquiring new skills that are different from the employee's current skill set) or may require more time and resources compared to the same required in the first set and second set of potential career roles. Moreover, while selecting the aspirational role, the employee may apply a filter 402 provided to select a specific domain, for example, “technology function”. Additionally, employees may select between viewing “all roles” 404 within that domain or filtering for “recommended roles” 406.

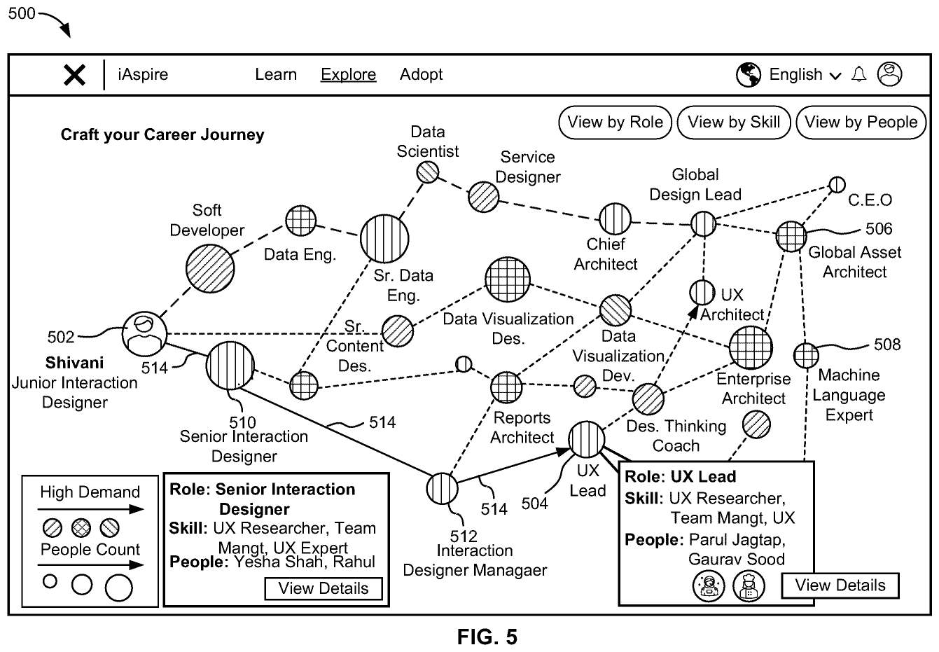

FIG. 5 illustrates an example graphical user interface 500 view of the career universe on the graphical user interface 224, in accordance with implementations of the present disclosure.

Herein, career progression of Shivani (Junior Interaction Designer) 502 may be displayed. Different recommended roles (for example, UX lead 504, global asset architect 506 and machine language expert 508) may be represented by bubbles. The bubbles may be sized based on their current headcount. The larger the size of the bubble, higher may be the number of employees belonging to that career role. Moreover, the solid lines may represent recommended shortest path or natural progression path to the aspirational role and the dotted lines may represent indirect path to the aspirational role. For instance, for Shivani (Junior Interaction Designer) 502 to become UX lead 504 down the line may be the shortest path. Thus, the solid line 514 may represent the career roles recommended in the shortest path, such as senior interaction designer 510, interaction designer manager 512 and consequently UX lead 504. However, if the aspirational role for Shivani (Junior Interaction Designer) 502 is global asset architect 506, then the various dotted lines may represent the indirect path to the aspirational role.

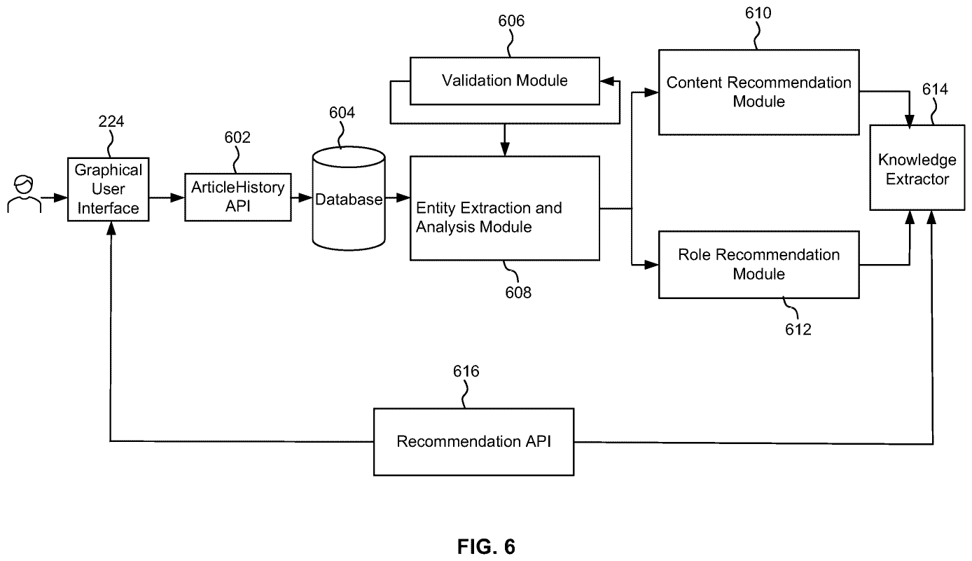

FIG. 6 illustrates an example block diagram that represents personalized content and role recommendations to the employees based on their article history, in accordance with implementations of the present disclosure. Herein, the employee's information of interaction with the article feed (for instance opening, browsing, liking/disliking) may be captured by the graphical user interface 224. The information of interaction with the article feed may be sent to a article history API 602, which includes details like employee ID, content URL, browsing times, and user feedback. The received data from the article history API 602 including employee's article history may be stored in a database 604. For example, the data may be stored in the employee and article history tables, maintaining a one-to-many relationship between the employee and their article interactions, since the employee may have multiple article histories. Furthermore, the entity extraction and analysis module 608 may utilize machine learning techniques to process the received data from the database 604. Specifically, the entity extraction and analysis module 608 may parse the content of the articles in the employee's history and perform entity extraction to identify relevant entities within the text. The existing entities may be compared to the identified entities to find new or incremental entities. Moreover, the entity extraction and analysis module 608 may determine relationships between triples (subject, predicate, object) represent skills, interests, and roles. Moreover, a validation module 606 may be provided to ensure the accuracy and quality of the extracted entities before they are added to a knowledge extractor 614, thereby maintaining the integrity and reliability of the recommendations generated by the system.

Specifically, the validation module 606 may utilize automated techniques such as, but not limited to, rule-based validation and machine learning models. The rule-based validation may include utilizing automated rules to check for inconsistencies or errors in the extracted entities. The machine learning models may be trained to identify and correct potential errors in entity extraction. Initial validation may be performed using automated techniques, such as rule-based checks or machine learning models. Additionally, the validated entities may be submitted to domain experts for review. The domain experts may use their knowledge to assess the accuracy, completeness, and relevance of the entities. Moreover, a workflow is established to guide the approval process. This may include multiple steps, such as initial review, verification, and final approval. The domain experts at different levels may be involved in the approval process, depending on the complexity or sensitivity of the entities.

Thereafter, the content recommendation module 610 may generate similar content based on trending articles and the reading habits of other employees. The content recommendation module 610 may generate content based on relevance of training with respect to entities extracted, current training and learning repository and what others are reading. Specifically, the content recommendation module 610 may analyze the entities extracted from an employee's article history from article history API 602 and identify training courses or materials that are directly related to these entities, ensuring that recommendations are aligned with the employee's current interests and areas of expertise. Moreover, the content recommendation module 610 may analyze the employee's existing training history to recommend content that complements their current learning path or addresses knowledge gaps. Additionally, by analyzing the reading habits of other employees with similar roles, skills, or interests, the content recommendation module 610 may identify trending or popular training topics.

Additionally, the role recommendation module 612 may derive mapping between roles and interests based on the extracted entities and relationships by the entity extraction and analysis module 608 and provide career role recommendation. The career role recommendation by the role recommendation module 612 may be based on skill, capability, career level, interest area and number of people in that role. Specifically, the role recommendation module 612 may recommend one or more career roles based on either the shortest path to the nearest matching skill of the employee or based on most popular skill amongst fellow employees. Furthermore, the career role may be a recommendation based on employee's current capability to which employee belongs to with his/her primary skill and in how many other capabilities require the particular skill. A plurality of career role recommendations may be provided for employees based on career level and skill set. The recommended career role may be a single role or multiple roles with shortest path recommendation. The career role recommendation provided to the employee may also be based on employee's reading interest area and relevant skills in market. Moreover, most popular role and interest area combination may be used to provide recommended career role to the employee. In essence, the recommendations provided by the role recommendation module 612 may be based on a combination of parameters skills, capability, career level, area of interest and number of people in the role. Each parameter may have a weighted skill percentage based on the overall distribution of number of people in that capability.

The knowledge extractor 614 may store data related to extracted entities, their relationships, and other relevant information derived from the employee's article history. The data may be used to generate recommendations, identify trends, and support various analytical tasks.

Furthermore, a recommendation API 616 may be provided to retrieve the most suitable recommendations for the user. Specifically, the recommendation API 616 may facilitate seamless integration and delivery of personalized recommendations to end-users.

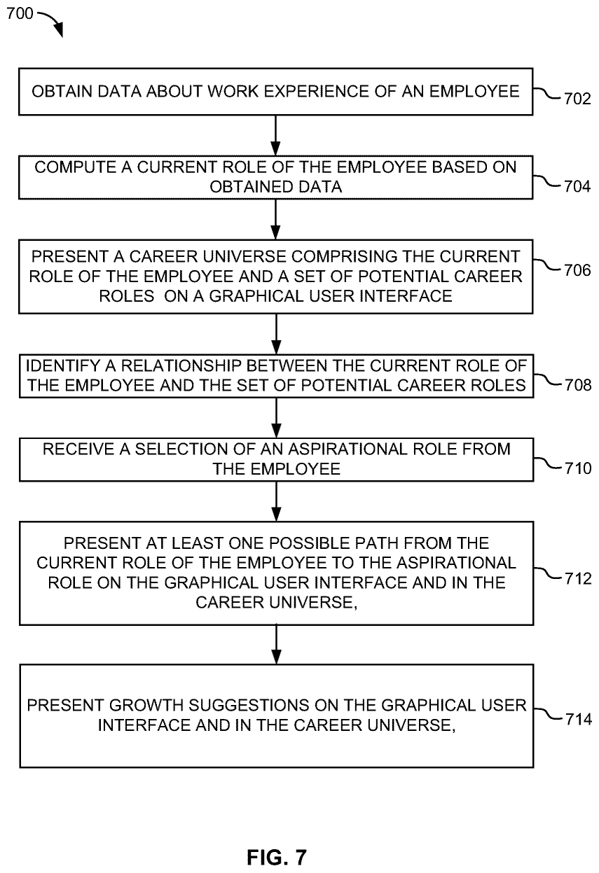

FIG. 7 illustrates a flow diagram of an example method for determining personalized career progression path, in accordance with implementations of the present disclosure. In some implementations, the method 700 may be executed within the system determining personalized career progression path as described in relation to FIG. 2.

At step 702, the method 700 may include obtaining data from a variety of different data source 202 systems about work experience of an employee. Specifically, the data may include one or more of the job family matrixes, primary skill data, secondary skill data, area of work data, connector data, learnings data, from and to connector data, experience level data, and work capability data.

At step 704, the method 700 may include computing, for the employee and based on the data and via the artificial intelligence (AI) model and the ontology model, the current role of the employee. Specifically, the computation module 220 may utilize the AI model trained by the knowledge inference engine 218 using the unsupervised approach to generate a knowledge graph by combining the data from the variety of different data source systems, data classification and triple extraction.

At step 706, the method 700 may include presenting, in a graphical user interface 224 configured on a display of a computing device, the career universe comprising the current role of the employee, a set of potential career roles comprising a first set of growth prospect roles presented in a first color, a second set of high affinity prospect roles in a second color and a third set of moderate or lower affinity prospect roles presented in a third color. Herein wherein the career universe may be presented in a precomputed manner based on skill computation rules related to one or more of capabilities, job families, and skill proficiency percentages.

At step 708, the method 700 may include identifying, in the career universe, the relationship between the current role of the employee and the set of potential career roles. Specifically, the computation module 220 may identify the relationships using the knowledge graph.

At step 710, the method 700 may include receiving, from the employee, the selection of the aspirational role from the set of potential career roles.

At step 712, the method 700 may include presenting, on the graphical user interface 224 and in the career universe, at least one possible path from the current role of the employee to the aspirational role, the at least one possible path comprising a shortest path to the aspirational role.

Consequently, at step 714, the method 700 may include presenting, in the graphical user interface 224 as part of the career universe, via a query to the knowledge graph and in the career universe, growth suggestions comprising one or more of an article, a certification or a learning experience for the employee to progress towards to the aspirational role.

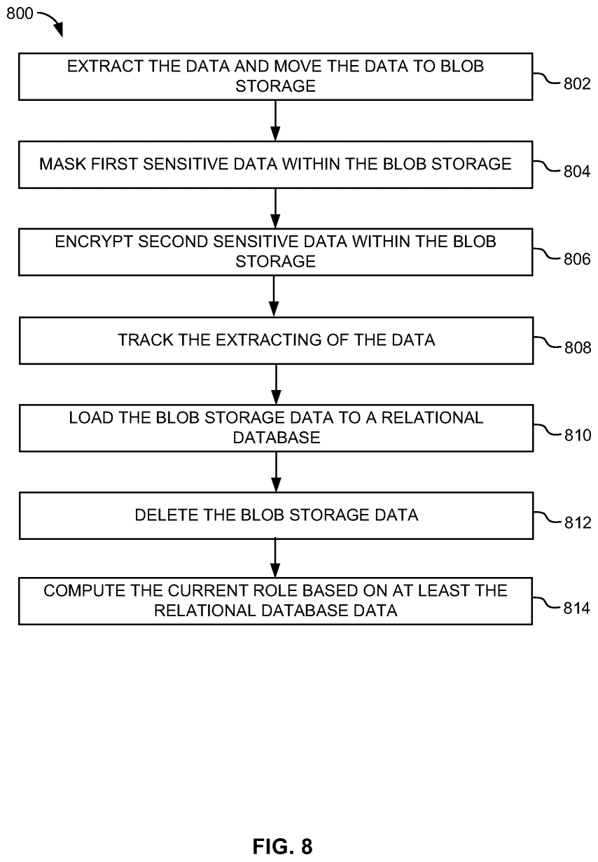

FIG. 8 illustrates a flow diagram of an example method for obtaining the data from the data source, in accordance with implementations of the present disclosure. In some implementations, the method 800 may be executed within the data extractor 208 as described in relation to FIG. 3.

At step 802, the method 800 may include, extracting the data from different data source 202 systems and moving the data to blob storage 312 to generate blob storage data. Specifically, the blob storage 312 may be the cloud-based storage service that stores unstructured data as blobs. The blob storage data may include files of any type, such as images, videos, documents, or raw data.

At step 804, the method 800 may include masking first sensitive data within the blob storage data to generate masked data. Specifically, the masking module 316 may identify the sensitive data (for example employee name and organization ID) and mask the sensitive data.

At step 806, the method 800 may include encrypting second sensitive data within the blob storage data to generate encrypted data. Specifically, the encryption module 318 may identify the sensitive data (for example employee name and organization ID) and encrypt the sensitive data.

At step 808, the method 800 may include, tracking the extracting of the data.

At step 810, the method 800 may include, loading the blob storage data to a relational database 320 to generate relational database data. Herein, the relational database data may include the masked data and the encrypted data.

At step 812, the method 800 may include, deleting, after loading the data to the relational database 320, the blob storage data. Specifically, the post-processing module 322 may delete the data from the blob storage 312, after the masked and encrypted data are loaded to the relational database 320.

Consequently, at step 814, the method 800 may include computing the current role based on at least the relational database data.

Implementations of the present disclosure provides technical solutions to multiple technical problems that arise in the context of determine personalized career progression path. For example, implementations of the present disclosure enable the system, by generating the ontology model, to compute the current role of the employee. Moreover, in the present disclosure, the entities may be derived from the data source 202 are connected by the relationships according to the unified schema and forms the knowledge graph. The connectedness of the knowledge graph is used to navigate through multiple paths between the current role of the employee and the aspired role. The external source 206 may feed more information about the employee and especially the skills through their articles and blogs and the roles for these skills can be derived on the fly and shown to the employee. The employee may also check the current demand for the role and choose an appropriate role as their desired role.

In the present disclosure, the knowledge graph may be semantic graph standard and may use open standard frameworks (for example World Wide Web Consortium(W3C)). Thus, different systems may work together with a common model. The different data dialects from the legacy systems may be easily translated into the RDF (Resource Description Framework).

Moreover, the data from both external source 206 and internal source 204 may be transformed into RDF data model which is based on triple format. The triple format is a simplified data structure yet presents a powerful meaning to the data. Each triple takes less space as compared to other data models and can be processed with low resources. Further, the knowledge inference engine 218 may provide low latency and high throughput query performance and may answer complex queries by traversing through millions of triples in milliseconds. The implementations of the present disclosure may save computer resources and operational data as well as reduce the infrastructure resource requirement for the organization.

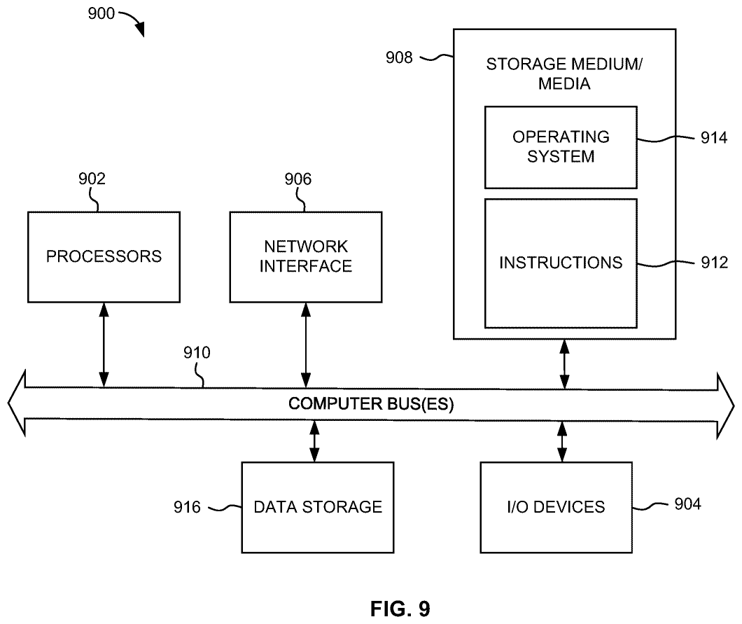

FIG. 9 illustrates a computer system 900 that may be used to implement the system to determine personalized career progression path. More particularly, computing machines such as desktops, laptops, smartphones, tablets, and wearables which may be used to implement the tasks that may have the structure of the computer system 900. The computer system 900 may include additional components not shown and that some of the process components described may be removed and/or modified. In another example, a computer system 900 may be deployed on external-cloud platforms such as cloud, internal corporate cloud computing clusters, organizational computing resources, and/or the like.

The computer system 900 includes processor(s) 902, such as a central processing unit, ASIC or another type of processing circuit, input/output devices 904, such as a display, mouse keyboard, etc., a network interface 906, such as a Local Area Network (LAN), a wireless 802.11x LAN, a 3G or 4G mobile WAN or a WiMax WAN, and a computer-readable medium 908. Each of these components may be operatively coupled to a bus 910. The computer-readable medium 908 may be any suitable medium that participates in providing instructions to the processor(s) 902 for execution. For example, the computer-readable medium 908 may be non-transitory or non-volatile medium, such as a magnetic disk or solid-state non-volatile memory or volatile medium such as RAM. The instructions or modules stored on the computer-readable medium 908 may include machine-readable instructions 912 executed by the processor(s) 902 that cause the processor(s) 902 to perform the methods and functions of the system to determine personalized career progression path.

The system may be implemented as software stored on a non-transitory processor-readable medium and executed by the processors 902. For example, the computer-readable medium 908 may store an operating system 914, such as MAC OS, MS WINDOWS, UNIX, or LINUX, and code for the system. The operating system 914 may be multi-user, multiprocessing, multitasking, multithreading, real-time, and the like. For example, during runtime, the operating system 914 is running and the code for the system is executed by the processor(s) 902.

The computer system 900 may include a data storage 916, which may include non-volatile data storage. The data storage 916 stores any data used or generated by the system.

The network interface 906 connects the computer system 900 to internal systems for example, via a LAN. Also, the network interface 906 may connect the computer system 900 to the Internet. For example, the computer system 900 may connect to web browsers and other external applications and systems via the network interface 906.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term computing system encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media, and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touchpad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (LAN) and a wide area network (WAN), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A method comprising:
obtaining data from a variety of different data source systems about work experience of an employee;
computing, for the employee and based on the data and via an artificial intelligence model and an ontology model, a current role of the employee, wherein the artificial intelligence model is trained using an unsupervised approach to generate a knowledge graph by combining the data from the variety of different data source systems, data classification and triple extraction;
presenting, in a graphical user interface configured on a display of a computing device, a career universe comprising the current role of the employee, a set of potential career roles comprising a first set of growth prospect roles presented in a first color, a second set of high affinity prospect roles in a second color and a third set of moderate or lower affinity prospect roles presented in a third color, wherein the career universe is presented in a precomputed manner based on skill computation rules related to one or more of capabilities, job families, and skill proficiency percentages;
identifying, in the career universe, a relationship between the current role of the employee and the set of potential career roles;
receiving, from the employee, a selection of an aspirational role from the set of potential career roles;
presenting, on the graphical user interface and in the career universe, at least one possible path from the current role of the employee to the aspirational role, the at least one possible path comprising a shortest path to the aspirational role; and
presenting, in the graphical user interface as part of the career universe, via a query to the knowledge graph and in the career universe, growth suggestions comprising one or more of articles, a certification or a learning experience for the employee to progress towards the aspirational role.

2. The method of claim 1, wherein the shortest path to the aspirational role is based on a fellow employee who has performed a role transition to the aspirational role.

3. The method of claim 1, wherein presenting, on the graphical user interface as part of the career universe, at least one possible path from the current role of the employee to the aspirational role further comprises presenting the shortest path to the aspirational role plus at least one of an indirect path to the aspirational role which comprises an intermediate role from the current role of the employee and a natural progression path to the aspirational role.

4. The method of claim 1, wherein the data comprises one or more of a job family matrix, primary skill data, secondary skill data, area of work data, connector data, learnings data, from and to connector data, experience level data, and work capability data.

5. The method of claim 4, wherein obtaining the data further comprises:
extracting the data from different data source systems and moving the data to blob storage to generate blob storage data;
masking first sensitive data within the blob storage data to generate masked data;
encrypting second sensitive data within the blob storage data to generate encrypted data;
tracking the extracted data;
loading the blob storage data to a relational database to generate relational database data, the relational database data comprising the masked data and the encrypted data;
deleting, after loading the data to the relational database, the blob storage data; and
computing the current role based on at least the relational database data.

6. The method of claim 5, wherein the obtaining of the data occurs as trigged by new data identified in one or more of the different data source systems or on a scheduled basis.

7. The method of claim 4, wherein:
the data at least in part is obtained from an external source comprising one or more of a job-related social media site, a microsite, time-series documents, a really simple syndication (RSS) feed, blogs, articles and a website for sharing human stories and ideas and wherein an entity extraction engine detects sentences in the data, tokenizes the data, extracts named entities from the data, extracts one or more subject/predicate/object from the data, performs predicate classification and validates a skill classification to generate a first ontology related to one or more of skill, training, learning material, certification, technology and career opportunity for use in model training and entity linking for the knowledge graph;
the data at least in part is obtained from an internal source comprising one or more of employee data, skill data, training certifications, demand data and credential data for the employee, wherein the data obtained from the internal source is used to generate one or more virtual graphs in which a database management system creates, via a resource description framework (RDF) data model, triples associated with the data obtained from the internal source using an ontology, validates constraints, defines axioms and defines user-defined rule reasoning to generate a second ontology related to one or more of the employee, a role, the skill, the job family matrix, a capability, a skill group, a demand and a project; and
the knowledge graph receives the first ontology and the second ontology to generate the knowledge graph with a dynamic ontology related to the employee, a roll, the skill, the job family matrix, the capability, the skill group, the training, the learning material, the certification, the technology, a career opportunity, the demand and the project, and wherein the method further comprises:
receiving, at the knowledge graph, a query in connection with the axioms and rules associated with the user-defined rule reasoning; and
providing a response from the knowledge graph for knowledge services related to one or more features of the career universe comprising: an employee role computation, data related to capabilities for all roles, all paths to the aspirational role, the shortest path to the aspirational role, a popular role, a natural role progression, a list of roles based on the demand, training/certification recommendations based on the skill, and career opportunities.

8. The method of claim 1, wherein the knowledge graph comprises a connectedness of the data such that the knowledge graph, via a unified schema, is used to nature through multiple paths between the current role and the aspirational role.

9. A system comprising:
at least one processor; and
a computer-readable medium storing instructions which, when executed by the at least one processor, cause the at least one processor to be configured to:
obtain data from a variety of different data source systems about work experience of an employee;
compute, for the employee and based on the data and via an artificial intelligence model and an ontology model, a current role of the employee, wherein the artificial intelligence model is trained using an unsupervised approach to generate a knowledge graph by combining the data from the variety of different data source systems, data classification and triple extraction;
present, in a graphical user interface configured on a display of a computing device, a career universe comprising the current role of the employee, a set of potential career roles comprising a first set of growth prospect roles presented in a first color, a second set of high affinity prospect roles in a second color and a third set of moderate or lower affinity prospect roles presented in a third color, wherein the career universe is presented in a precomputed manner based on skill computation rules related to one or more of capabilities, job families, and skill proficiency percentages;
identify, in the career universe, a relationship between the current role of the employee and the set of potential career roles;
receive, from the employee, a selection of an aspirational role from the set of potential career roles;
present, on the graphical user interface and in the career universe, at least one possible path from the current role of the employee to the aspirational role, the at least one possible path comprising a shortest path to the aspirational role; and
present, in the graphical user interface, via a query to the knowledge graph and in the career universe, a growth suggestion comprising one or more of articles, certifications or learning experiences for the employee to progress towards the aspirational role.

10. The system of claim 9, wherein the shortest path to the aspirational role is based on a fellow employee who has performed a role transition to the aspirational role.

11. The system of claim 9, wherein the at least one processor to be configured to present, on the graphical user interface and in the career universe, at least one possible path from the current role of the employee to the aspirational role by presenting the shortest path to the aspirational role plus at least one of an indirect path to the aspirational role which comprises an intermediate role from the current role of the employee and a natural progression path to the aspirational role.

12. The system of claim 9, wherein the data comprises one or more of a job family matrix, primary skill data, secondary skill data, area of work data, connector data, learnings data, from and to connector data, experience level data, and work capability data.

13. The system of claim 12, wherein the at least one processor is configured to obtain the data by:
extracting the data from different data source systems and moving the data to blob storage to generate blob storage data;
masking first sensitive data within the blob storage data to generate masked data;
encrypting second sensitive data within the blob storage data to generate encrypted data;
tracking the extracting of the data;
loading the blob storage data to a relational database to generate relational database data, the relational database data comprising the masked data and the encrypted data;
deleting, after loading the data to the relational database, the blob storage data; and
computing the current role based on at least the relational database data.

14. The system of claim 13, wherein the at least one processor is configured to obtain the data occurs as trigged by new data identified in one or more of the different data source systems or on a scheduled basis.

15. The system of claim 13, wherein:
the data at least in part is obtained from an external source comprising one or more of a job-related social media site, a microsite, time-series documents, a really simple syndication (RSS) feed, blogs, articles and a website for sharing human stories and ideas and wherein an entity extraction engine detects sentences in the data, tokenizes the data, extracts named entities from the data, extracts one or more subject/predicate/object from the data, performs predicate classification and validates a skill classification to generate a first ontology related to one or more of skill, training, learning material, certification, technology and career opportunity for use in model training and entity linking for the knowledge graph;
the data at least in part is obtained from an internal source comprising one or more of employee data, skill data, training certifications, demand data and credential data for the employee, wherein the data obtained from the internal source is used to generate one or more virtual graphs in which a database management system creates, via a resource description framework (RDF) data model, triples associated with the data obtained from the internal source using an ontology, validates constraints, defines axioms and defines user-defined rule reasoning to generate a second ontology related to one or more of the employee, a role, the skill, the job family matrix, a capability, a skill group, a demand and a project; and
the knowledge graph receives the first ontology and the second ontology to generate the knowledge graph with a dynamic ontology related to the employee, a roll, the skill, the job family matrix, the capability, the skill group, the training, the learning material, the certification, the technology, a career opportunity, the demand and the project, and wherein the at least one processor is configured to:
receive, at the knowledge graph, a query in connection with the axioms and rules associated with the user-defined rule reasoning; and
provide a response from the knowledge graph for knowledge services related to one or more features of the career universe comprising: an employee role computation, data related to capabilities for all roles, all paths to the aspirational role, the shortest path to the aspirational role, a popular role, a natural role progression, a list of roles based on the demand, training/certification recommendations based on the skill, and career opportunities.

16. The system of claim 9, wherein the knowledge graph comprises a connectedness of the data such that the knowledge graph, via a unified schema, is used to nature through multiple paths between the current role and the aspirational role.

17. A computer-readable medium storing instructions which, when executed by at least one processor, cause the at least one processor to be configured to:
obtain data from a variety of different data source systems about work experience of an employee;
compute, for the employee and based on the data and via an artificial intelligence model and an ontology model, a current role of the employee, wherein the artificial intelligence model is trained using an unsupervised approach to generate a knowledge graph by combining the data from the variety of different data source systems, data classification and triple extraction;
present, in a graphical user interface configured on a display of a computing device, a career universe comprising the current role of the employee, a set of potential career roles comprising a first set of growth prospect roles presented in a first color, a second set of high affinity prospect roles in a second color and a third set of moderate or lower affinity prospect roles presented in a third color, wherein the career universe is presented in a precomputed manner based on skill computation rules related to one or more of capabilities, job families, and skill proficiency percentages;
identify, in the career universe, a relationship between the current role of the employee and the set of potential career roles;
receive, from the employee, a selection of an aspirational role from the set of potential career roles;
present, on the graphical user interface and in the career universe, at least one possible path from the current role of the employee to the aspirational role, the at least one possible path comprising a shortest path to the aspirational role; and
present, in the graphical user interface, via a query to the knowledge graph and in the career universe, a growth suggestion comprising one or more of articles, certifications or learning experiences for the employee to progress towards the aspirational role.

18. The computer-readable medium of claim 17, wherein the data comprises one or more of a job family matrix, primary skill data, secondary skill data, area of work data, connector data, learnings data, from and to connector data, experience level data, and work capability data.

19. The computer-readable medium of claim 18, wherein the at least one processor is configured to obtain the data by:
extracting the data from different data source systems and moving the data to blob storage to generate blob storage data;
masking first sensitive data within the blob storage data to generate masked data;
encrypting second sensitive data within the blob storage data to generate encrypted data;
tracking the extracting of the data;
loading the blob storage data to a relational database to generate relational database data, the relational database data comprising the masked data and the encrypted data;
deleting, after loading the data to the relational database, the blob storage data; and
computing the current role based on at least the relational database data.

20. The computer-readable medium of claim 19, wherein:
the data at least in part is obtained from an external source comprising one or more of a job-related social media site, a microsite, time-series documents, a really simple syndication (RSS) feed, blogs, articles and a website for sharing human stories and ideas and wherein an entity extraction engine detects sentences in the data, tokenizes the data, extracts named entities from the data, extracts one or more subject/predicate/object from the data, performs predicate classification and validates a skill classification to generate a first ontology related to one or more of skill, training, learning material, certification, technology and career opportunity for use in model training and entity linking for the knowledge graph;
the data at least in part is obtained from an internal source comprising one or more of employee data, skill data, training certifications, demand data and credential data for the employee, wherein the data obtained from the internal source is used to generate one or more virtual graphs in which a database management system creates, via a resource description framework (RDF) data model, triples associated with the data obtained from the internal source using an ontology, validates constraints, defines axioms and defines user-defined rule reasoning to generate a second ontology related to one or more of the employee, a role, the skill, the job family matrix, a capability, a skill group, a demand and a project; and
the knowledge graph receives the first ontology and the second ontology to generate the knowledge graph with a dynamic ontology related to the employee, a roll, the skill, the job family matrix, the capability, the skill group, the training, the learning material, the certification, the technology, a career opportunity, the demand and the project, and wherein the at least one processor is configured to:
receive, at the knowledge graph, a query in connection with the axioms and rules associated with the user-defined rule reasoning; and
provide a response from the knowledge graph for knowledge services related to one or more features of the career universe comprising: an employee role computation, data related to capabilities for all roles, all paths to the aspirational role, the shortest path to the aspirational role, a popular role, a natural role progression, a list of roles based on the demand, training/certification recommendations based on the skill, and career opportunities.
